(19) United States
(12) Patent Application Publication
(10) Pub. No.: US 2013/0309038 A1
(43) Pub. Date: Nov. 21, 2013

(54) Repositionable Trailer Tie-Down Bracket

(71) Applicant: Steve Starr, Madisonville, KY (US)

(72) Inventor: Steve Starr, Madisonville, KY (US)

(21) Appl. No.: 13/872,369

(22) Filed: Apr. 29, 2013

Related U.S. Application Data
(60) Provisional application No. 61/647,126, filed on May 15, 2012.

(51) Int. Cl. B60P 7/08

(52) U.S. Cl. CPC B60P 7/0807
USPC 410/106

(57) ABSTRACT

The present invention pertains to a trailer tie-down bracket that may be removably attached to, and repositioned along, a trailer frame and/or rail without having to permanently alter the trailer frame and/or rails (e.g., by drilling holes therein). The trailer tie-down bracket is preferably comprised of a clamp portion for removable and repositionable attachment to a trailer frame, an eye-bolt attached to said clamp, a fastener for removably attaching said clamp to the frame or rail and a locking nut for locking the same in a desired position. The trailer tie-down bracket enables a user to (i) securely transport a trailer load by offering a secure anchoring point to which tie-downs can be secured and that can be attached to a trailer frame and/or rail without altering the same; and (ii) reposition the trailer tie-down bracket along the frame to suit the user's needs and/or a particular application.

### CROSS-REFERENCE

This application claims priority from Provisional Patent Application Ser. No. 61/647,126 filed on May 15, 2012.

### FIELD OF THE INVENTION

This invention relates to a repositionable trailer tie-down bracket for attachment to a rail or frame on a trailer.

### BACKGROUND

Many outdoor enthusiasts, homeowners, craftsman, farmers and other folks utilize small utility trailers attached to their vehicles to transport their gear, equipment or other articles to their destination. Many of the same trailers are comprised of frames with what is commonly referred to as “angle iron” rails. Unfortunately, said trailer frames and rails typically do not have an adequate place to attach tie-down straps to secure the trailer contents. Further, drilling into the frame and/or rail to install a tie-down attachment point, such as an eye-bolt, tends to weaken the trailer frame and does not permit for the repositioning of said attachment points once installed. Drilling holes into the frame of the trailer may also unintentionally impact the trailer's load rating, which is also undesirable.

Consequently, there is a long felt need in the art for a trailer tie-down bracket that can be removably attached to a trailer without permanently altering the trailer frame and or rails by, for example, drilling holes in the same. There is also a long felt need for a trailer tie-down bracket that can be relatively easily and quickly repositioned along the rail or frame of a trailer to suit user need or a particular application. Finally, there is a long felt need for a repositionable trailer tie-down bracket that accomplishes all of the forgoing objectives, and that is relatively inexpensive to manufacture and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed herein, in one aspect thereof, is a trailer tie-down bracket that can be removably attached to, and repositioned along, a trailer frame and/or rail without having to permanently alter the trailer frame and/or rails (e.g., by drilling holes therein). In a preferred embodiment of the present invention, the trailer tie-down bracket is comprised of a generally C-shaped beam clamp for removable and repositionable attachment to a trailer frame, an eye-bolt attached to said beam clamp, a fastener for removably attaching said beam clamp to the frame or rail and a locking nut for locking the same in position. The eye clamp provides a convenient anchoring point for temporarily securing trailer tie-downs that are, in turn, used to secure a trailer load to ensure that the load arrives at its destination in an undamaged state.

The trailer tie-down bracket enables a user to (i) securely transport a trailer load by offering a secure anchoring point to which tie-downs can be secured and that can be attached to a trailer frame and/or rail without altering or damaging the same; and (ii) reposition the trailer tie-down bracket along the frame to suit the user's needs and/or a particular application. Finally, the repositionable trailer tie-down bracket of the present invention is relatively inexpensive to manufacture and safe and easy to install and use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 is a perspective view of a preferred embodiment of the trailer tie-down bracket of the present invention.

FIG. 2 is a perspective exploded view of a preferred embodiment of the trailer tie-down bracket of the present invention.

FIG. 3 is a perspective view of a preferred embodiment of the trailer tie-down bracket of the present invention attached to a prior art trailer rail.

FIG. 4 is a perspective view of a preferred embodiment of the trailer tie-down bracket of the present invention attached to a prior art trailer rail, and being used to tie-down an all terrain vehicle.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

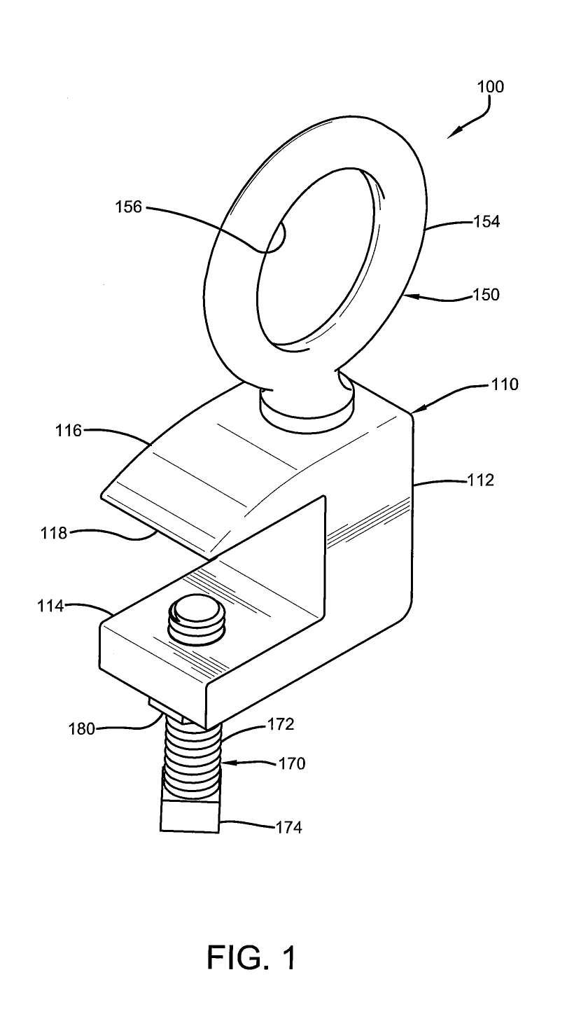

Referring initially to the drawings, FIG. 1 illustrates a perspective view of a preferred embodiment of the trailer tie-down bracket 100 of the present invention. Tie-down bracket 100 is preferably comprised of a clamp portion 110, a tie-down portion 150, a fastener 170 and a locking nut 180. Unless otherwise stated herein, tie-down bracket 100 and its various components are preferably comprised of a durable, generally weather resistant material such as galvanized steel. Nonetheless, it is also contemplated that tie-down bracket 100 and its various components could also be comprised of various other materials such as non-galvanized, painted steel, iron or the like, provided that the materials used can withstand the strain and stresses of the particular application.

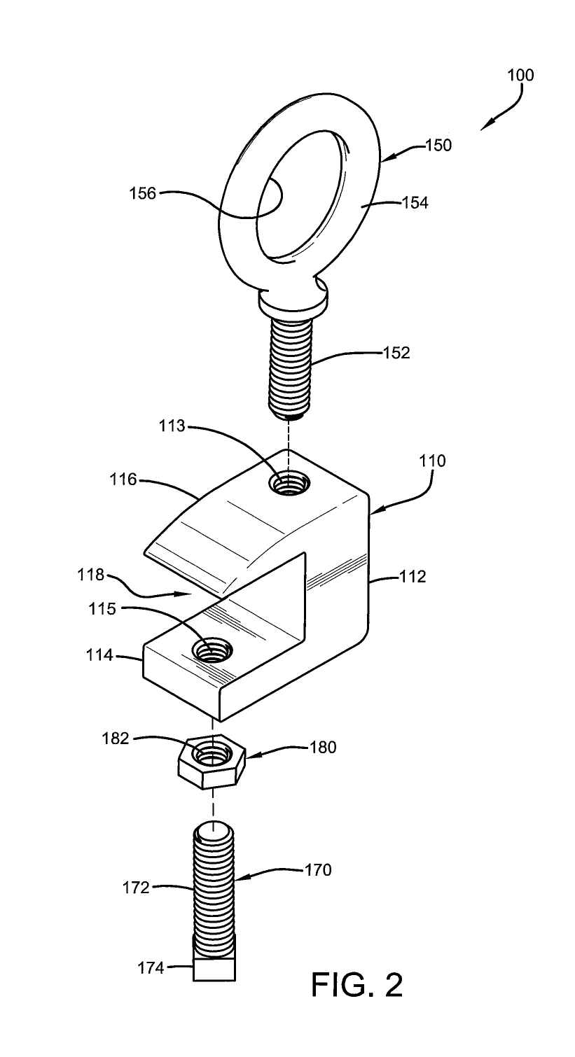

In a preferred embodiment of the present invention, clamp portion 110 is integrally formed and generally C-shaped, and comprised of a body 112, a first arm 114 and a second arm 116 and has a load rating of at least 300 lbs. Body portion 112 further comprises a threaded opening 113 therein for receipt of tie-down portion 150, as described more fully below. As best illustrated in FIGS. 1 and 2, each of first arm 114 and second arm 116 extend outwardly from said body portion 112 in spaced apart relationship, thereby forming a channel 118 for receipt of a portion of a frame or rail, as described more fully below. In a preferred embodiment of the present invention, the height of channel 118, as measured between first arm 114 and second arm 116 is between ½ and 1¾ inches to accommodate most sizes of rail and/or frame member.

As best seen in the FIGS, first arm 114 preferably further comprises a continuous opening 115 therein for receipt of fastener 170, the structure of which is further described below. Fastener 170 is useful for quickly and removably attaching bracket 100 to a trailer rail or frame once the trailer rail or frame is positioned within channel 118.

FIG. 2 is a perspective exploded view of a preferred embodiment of the trailer tie-down bracket 100 of the present invention. Tie-down portion 150 may be integrally formed (e.g., an eye-bolt) and is comprised of an elongated member 152 for insertion into opening 113 in body portion 112, and an eyelet 154 with a continuous opening 156 therein for receipt of a trailer tie-down strap or hook as described more fully below. A portion of elongated member 152 may be threaded to correspond to the threaded opening 113 in clamp portion 110 and to removably secure tie-down portion 150 to clamp portion 110. Alternatively, it is also contemplated that clamp portion 110 and tie-down portion 150 may be integrally formed as a single unit.

FIG. 2 also illustrates the structure of fastener 170 and its interplay with clamp portion 110. More specifically, fastener 170 can be any type of threaded fastener that is known in the art, such as a bolt, a screw, etc., and is preferably comprised of an elongated body portion 172 and a head portion 172. Body portion 172 is preferably threaded and corresponds in diameter to threaded continuous opening 115 in first arm 114. Further, the overall length of body portion 172 should be such that it is long enough to extend through continuous opening 115 and span the length of channel 118, as measured between first and second arms 114, 116, respectively. Head portion 174 may be comprised of any of shape, size and/or configuration as is known in the art for the head of a fastener, and is useful in enabling a user (not shown) to turn body portion 172 within threaded opening 115 to move fastener 170 into and out of channel 118.

As previously mentioned, bracket 100 may further comprise a locking nut 180 that can be positioned along threaded body portion 172, between head portion 174 and first arm 114, to lock or secure fastener 170 in a desired position relative to channel 118, as explained more fully below. Locking nut 180 may be any type of locking nut that is commonly known in the art provided that it can accommodate the particular size of the fastener 170 being used.

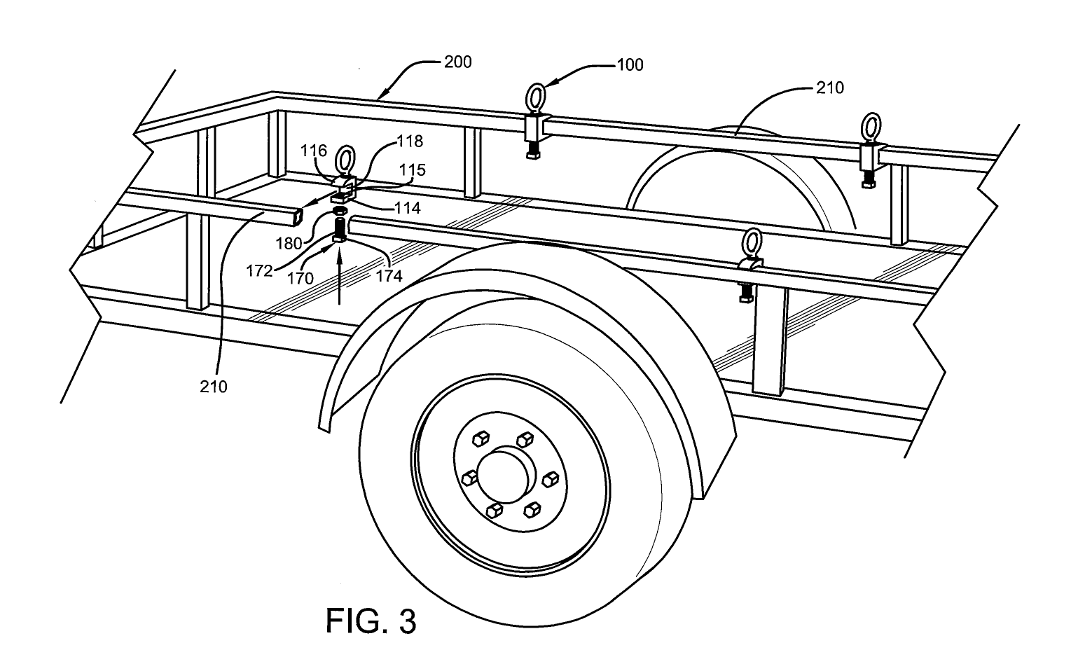

Having described the overall structure of repositionable trailer tie-down bracket 100 of the present invention, it's use and usefulness will now be described. A user (not shown) desiring to secure a load in a prior art trailer 200, may attach one or more brackets 100 of the present invention at desired positions along a trailer rail 210, as best shown in FIG. 3. To attach bracket 100 to trailer rail 210, a user would simply unthread fastener 170 far enough out of threaded opening 115 to allow trailer rail 210 to fit within channel 118. Once trailer rail 115 is positioned in channel 118 between first arm 114 and second arm 116, fastener 170 can again be threaded into continuous opening 115 by rotating head portion 174 in a clockwise direction until trailer rail 210 is secured between fastener 170 and second arm 116. Once bracket 100 has been removably secured to trailer rail 210 in a desired location, the user (not shown) can turn locking nut 180 in a clockwise direction along body portion 172 until it is snug against first arm 114, thereby locking fastener 170 in place and preventing it from prematurely loosening from trailer rail 210.

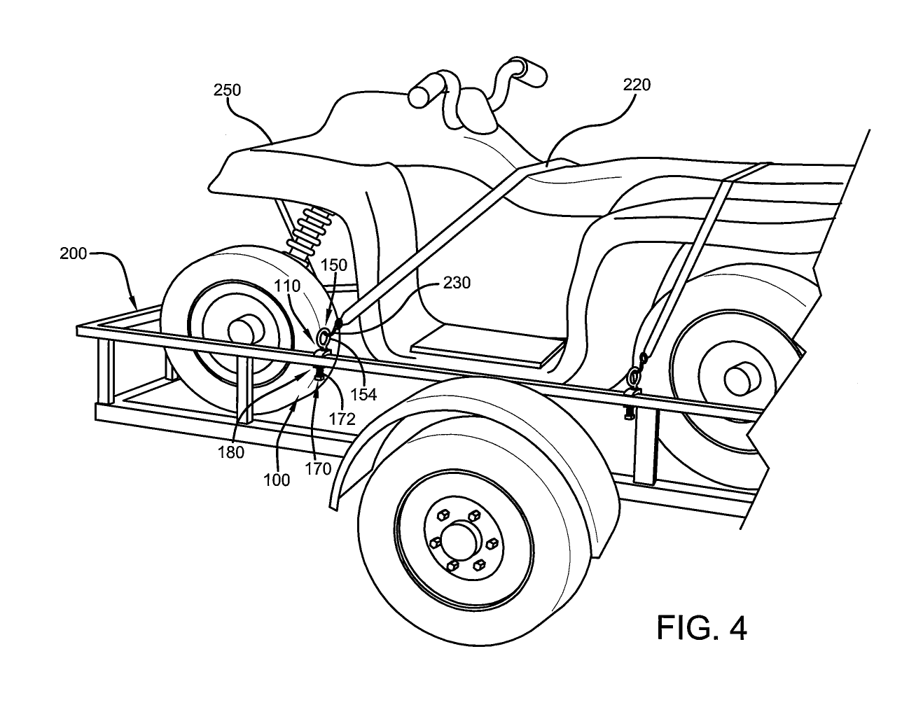

Once clamp portion 110 is secured to trailer rail 210, if tie-down portion 150 is not already attached to clamp portion 110 it can now be installed by screwing threaded elongated member 152 in a clockwise direction into opening 113 in body 112. Once installed, a tie-down hook 230 attached to a tie down strap 220 can be removably attached to bracket 100 by inserting hook 230 into eyelet 154 to secure a load, such as an all terrain vehicle 250, to trailer 200, as best shown in FIG. 4. Moreover, to unsecure the load, or reposition one or more of brackets 100 along trailer rail 210, a user (not shown) simply (i) loosens locking nut 180 by unthreading the same along body portion 172 in a counter-clockwise direction away from first arm 114, and then (ii) loosens fastener 170 from trailer rail 210 by unthreading fastener 170 through continuous opening 115 in first arm from the same along body portion 172 in a counter-clockwise direction away from trailer rail 210.

In this manner, improved trailer tie-down bracket can be removably attached to a trailer without permanently altering the trailer frame and or rails, and without the need to drill holes in the trailer frame that could impact the trailer's load rating. The trailer tie-down bracket of the present invention can also be easily repositioned along the rail or frame of a trailer to suit the user's need and/or a particular application, and can be used to better secure the trailer's load. Finally, the repositionable trailer tie-down bracket is relatively inexpensive to manufacture and safe and easy to use.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading, the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A tie-down bracket for attachment to a trailer with a frame and a rail, comprising:
a clamp portion;
a tie-down portion;
a fastener; and
a locking nut.

2. The tie-down bracket of claim 1, wherein said clamp portion is generally C-shaped and is further comprised of a channel for receipt of a trailer rail or frame.

3. The tie-down bracket of claim 1, wherein said tie-down portion is an eye-bolt.

4. The tie-down bracket of claim 1, wherein said fastener is a threaded bolt.

5. The tie-down bracket of claim 1, wherein said clamp portion is further comprised of a body, a first arm and a second arm.

6. The tie-down bracket of claim 5, wherein said first arm further comprises an opening therein for receipt of said fastener.

7. The tie-down bracket of claim 2, wherein said clamp portion further comprises a body, a first arm and a second arm and wherein said fastener extends through an opening in said first arm and into the channel.

8. The tie-down bracket of claim 1, wherein said clamp portion is comprised of galvanized steel.

9. A tie-down bracket for attachment to a trailer with a frame and a rail, comprising:
a generally C-shaped clamp portion comprised of a channel for receiving a portion of said rail or said frame;
an eye-bolt attached to said generally C-shaped clamp portion;
a fastener; and
a locking nut.

10. The tie-down bracket of claim 9, wherein said fastener is a threaded bolt.

11. The tie-down bracket of claim 9, wherein said generally C-shaped clamp portion is further comprised of a body, a first arm and a second arm.

12. The tie-down bracket of claim 11, wherein said first arm further comprises an opening therein for receipt of said fastener.

13. The tie-down bracket of claim 9, wherein said generally C-shaped clamp portion further comprises a body, a first arm and a second arm and wherein said fastener extends through an opening in said first arm and into the channel.

14. The tie-down bracket of claim 9, wherein said generally C-shaped clamp portion is comprised of galvanized steel.

15. The tie-down bracket of claim 9, wherein said locking nut secures the fastener in a desired location within said channel.

16. A tie-down bracket for attachment to a trailer with a frame and a rail, comprising:
a generally C-shaped clamp portion comprised of a first arm, a body portion, a second arm, and a channel formed by said first arm, said second arm and said body portion;
a tie-down portion attached to said generally C-shaped clamp portion;
a fastener; and
a locking nut.

17. The tie-down bracket of claim 16, wherein said fastener is a threaded bolt.

18. The tie-down bracket of claim 16, wherein said first arm further comprises an opening therein for receipt of said fastener.

19. The tie-down bracket of claim 18, wherein said fastener extends through the opening in said first arm and into the channel.

20. The tie-down bracket of claim 16, wherein said rail is positioned between an end of the fastener and the second arm and secured by the locking nut.
